(19) United States
(12) Patent Application Publication
(10) Pub. No.: US 2002/0051552 A1
(43) Pub. Date: May 2, 2002

(54) Dual chamber acoustic enclosure with triple venting using passive radiators

(75) Inventor: Wayne M. Schott, Seymour, TN (US)

Correspondence Address: Michael E. Marion, c/o U.S. PHILIPS CORPORATION, Intellectual Property Department, 580 White Plains Road, Tarrytown, NY, 10591, US

(73) Assignee: KONINLIJKE PHILIPS ELECTRONICS N.V.

(21) Appl. No.: 10/017,691

(22) Filed: Dec. 14, 2001

Related U.S. Application Data
(63) Continuation-in-part of application No. 09/464,867, filed on Dec. 16, 1999, now abandoned.

(51) Int. Cl. H04R 1/02; H04R 1/20

(52) U.S. Cl. 381/345; 381/349; 381/351

(57) ABSTRACT

A loudspeaker system includes an acoustical enclosure having an internal wall for dividing the enclosure into first and second sub-chambers. An electro-acoustical transducer having a vibratable speaker cone is mounted in an opening provided in the internal wall of the acoustical enclosure, while an internal vent is provided in the internal wall of the acoustical enclosure for pneumatically coupling the first and second sub-chambers. An external vent is provided in a wall of the first sub-chamber for pneumatically coupling the first sub-chamber to an exterior environment outside of the acoustical enclosure. Finally, a passive radiator is provided in a wall of the second sub-chamber for pneumatically coupling the second sub-chamber to the exterior environment.

### CROSS-REFERENCE TO RELATED APPLICATIONS

This is a continuation-in-part of Applicant's co-pending U.S. patent application Ser. No. 09/464,867, filed Dec. 16, 1999.

### BACKGROUND OF THE INVENTION

1. Field of the Invention

The present invention relates generally to the field of loudspeakers, and more particularly, to a loudspeaker having a dual chamber acoustic enclosure with two external vents and one internal vent.

2. Description of the Related Art

A common objective in designing loudspeaker systems is to improve acoustical performance in the operating band of the system and to minimize distortion caused by, among other things, loudspeaker cone excursions at frequencies at and below a lower cutoff frequency of the system.

In general, when a loudspeaker is energized, its electro-acoustic transducer diaphragm (“cone”) reciprocates or vibrates at a frequency which varies with the signal input to the loudspeaker. When an unmounted or unbaffled loudspeaker is operated in a so-called “free air” mode, its cone exhibits large mechanical excursions as it approaches its resonant frequency, which produces significant acoustical distortion. In order to control this motion and thereby reduce the distortion level of the loudspeaker, it is customary to mount the loudspeaker in some form of housing or loudspeaker enclosure.

In its simplest form, this enclosure is a closed box with the loudspeaker mounted or suspended in an opening in one wall thereof. Such a loudspeaker system causes the large amplitudes of the loudspeaker cone excursions to occur at a different frequency, thus changing the resonant frequency of the loudspeaker relative to its resonant frequency in its “free air” mode of operation.

U.S. Pat. No. 4,549,631 to Bose, discloses an acoustic suspension loudspeaker system that has an acoustical enclosure of rectangular cross-section with a baffle dividing the interior of the enclosure into first and second sub-chambers. The acoustical enclosure of the loudspeaker system disclosed by Bose is commonly referred to as a “bass reflex” enclosure. Each sub-chamber of this enclosure has a port tube (“vent”) that couples the respective sub-chamber to the exterior environment outside of the enclosure. The dividing baffle carries a woofer. This type of acoustical enclosure can be thought of as a dual chamber acoustical enclosure having two “external” vents. Each external vent serves as a passive radiating means. More particularly, each external vent provides an acoustic mass that constitutes an extra reactance which can be used to tailor the frequency response of the loudspeaker system at the low end. A ported or vented system is characterized by a resonance (port resonance) at which the mass of air in the port (vent) reacts with the volume of air within the enclosure to create a resonance at which the excursion of the loudspeaker cone is minimized. The dual chamber acoustical enclosure provided with two external vents disclosed by Bose provides improved sensitivity at port resonance which results in an extension of the lower cutoff frequency of the loudspeaker system to a lower value, while also reducing loudspeaker cone excursions in the vicinity of the lower cutoff frequency of the loudspeaker system.

However, in order for bass reflex loudspeakers of the type disclosed in the Bose patent to achieve a flat band-pass response, a loudspeaker driver with a rather high magnetic efficiency is required. This type of loudspeaker driver is expensive. Moreover, bass reflex loudspeaker systems which utilize two sub-chambers having ports for directly acoustically coupling each of the respective sub-chambers to the exterior environment, tend to provide poor response for acoustic frequencies falling between the resonant frequencies of the two sub-chambers and their corresponding respective ports when the resonant frequencies of the two sub-chambers vary by more than a factor of 3 to 1.

U.S. Pat. No. 4,875,546 to Krnan, discloses a two-chamber bass reflex-type loudspeaker that overcomes the above-noted deficiency of the Bose loudspeaker system. In particular, the Krnan loudspeaker system exhibits good frequency response for frequencies between the resonant frequencies of the two sub-chambers of the two-chamber enclosure, even when these resonant frequencies are separated by a factor of up to 10 to 1. The Krnan loudspeaker system includes a first sub-chamber that is pneumatically and acoustically coupled with the second sub-chamber via a first port (vent) that is sized to enclose a first acoustic mass of air while one of the sub-chambers is pneumatically and acoustically coupled with the outside environment via a second port (vent) that is sized to enclose a second acoustic mass of air. By properly constructing the first and second sub-chambers and first and second ports, the acoustical enclosure will operate as an acoustical band-pass filter in which high frequency distortion components, such as those generated by diaphragm excursions of the transducer (speaker cone), will be acoustically attenuated.

Although the Krnan loudspeaker system described above does overcomes some of the problems inherent with electrical filtering via crossover networks, and does exhibit better performance over a broader operating band than the Bose loudspeaker system described above, it still has significant drawbacks and shortcomings. More particularly, the efficiency of the Krnan loudspeaker system is less than desirable, and the distortion products generated in the vicinity of the lower cutoff frequency are greater than is desirable.

It should be mentioned that Japanese Published Application Number 4-301998 to Tamura discloses a dual-chamber loudspeaker system that features a “triple-vented” acoustical enclosure, with two “external” vents that pneumatically and acoustically couple respective sub-chambers to the exterior environment, and one “internal” vent that pneumatically and acoustically couples the first and second sub-chambers of the enclosure to one another. This dual-chamber, triple-vented loudspeaker system is a low band (i.e., bass) loudspeaker system. The internal vent is specifically designed and used to minimize distortion due to loudspeaker cone excursions at frequencies lower than the resonant frequency (i.e., it sharpens the upper cutoff frequency of the bass speaker), but does not contribute to acoustical output within the normal operating band. In fact, Tamura teaches that even in the narrow low frequency band of interest in his system, the internal vent actually acts as a bypass circuit whose effect is to reduce the acoustical output from the external vents, as well as to reduce the level of the distortion.

Applicant's co-pending U.S. patent application Ser. No. 09/464,867, filed Dec. 16, 1999 (Attorney Docket No. PHA 23,820), discloses a loudspeaker that includes an acoustical enclosure that has an internal wall that divides the enclosure into first and second sub-chambers, an electro-acoustical transducer having a vibratable speaker cone mounted in an opening provided in the internal wall of the acoustical enclosure, an internal vent provided in the internal wall of the acoustical enclosure for pneumatically coupling the first and second sub-chambers, a first external vent provided in a wall of the first sub-chamber for pneumatically coupling the first sub-chamber to an exterior environment outside of the acoustical enclosure, and a second external vent provided in a wall of the second sub-chamber for pneumatically coupling the second sub-chamber to the exterior environment. In one embodiment, a ratio of the acoustic mass of the internal vent to the acoustic mass of the second external vent is in a range of approximately 3/1 to 7/1. In another embodiment, a ratio of the acoustic mass of the first external vent to the acoustic mass of the second external vent is in a range of approximately 15/1 to 30/1. In both embodiments, a ratio of the volume of the first sub-chamber to the volume of the second sub-chamber is in a range of approximately 0.3 to 2.5.

### SUMMARY OF THE INVENTION

Applicant has found that by replacing one or more of the ducted vents of the loudspeaker system with passive radiators, the usable internal volume of the loudspeaker enclosure is increased leading to more enhanced performance of the loudspeaker system. Alternatively, using at least one passive radiator in place of at least one of the ducted vents, the enclosure may be made smaller while retaining substantially the same performance of the loudspeaker system as a larger enclosure with only ducted vents.

### BRIEF DESCRIPTION OF THE DRAWINGS

With the above and additional objects and advantages in mind as will hereinafter appear, the subject invention will be described with reference to the accompanying drawings, in which:

FIG. 1 shows an elevational view, partly in section, of a loudspeaker enclosure having dual chambers, an internal vent connecting the two sub-chambers, and two external vents connecting the two sub-chambers, respectively, with the outside;

FIG. 2 shows a graph of the response curve for the loudspeaker system of FIG. 1;

FIG. 3 shows an elevational view, partly in section, of a first embodiment of the loudspeaker system of the subject invention;

FIG. 4 shows a graph of the response curve for the loudspeaker system of FIG. 3;

FIG. 5 shows an elevational view, partly in section, of a second embodiment of the loudspeaker system of the subject invention;

FIG. 6 shows a graph of the response curve for the loudspeaker system of FIG. 5;

FIG. 7 shows an elevational view, partly in section, of a third embodiment of the loudspeaker system of the subject invention; and

FIG. 8 shows a graph of the response curve for the loudspeaker system of FIG. 7.

### DESCRIPTION OF THE PREFERRED EMBODIMENTS

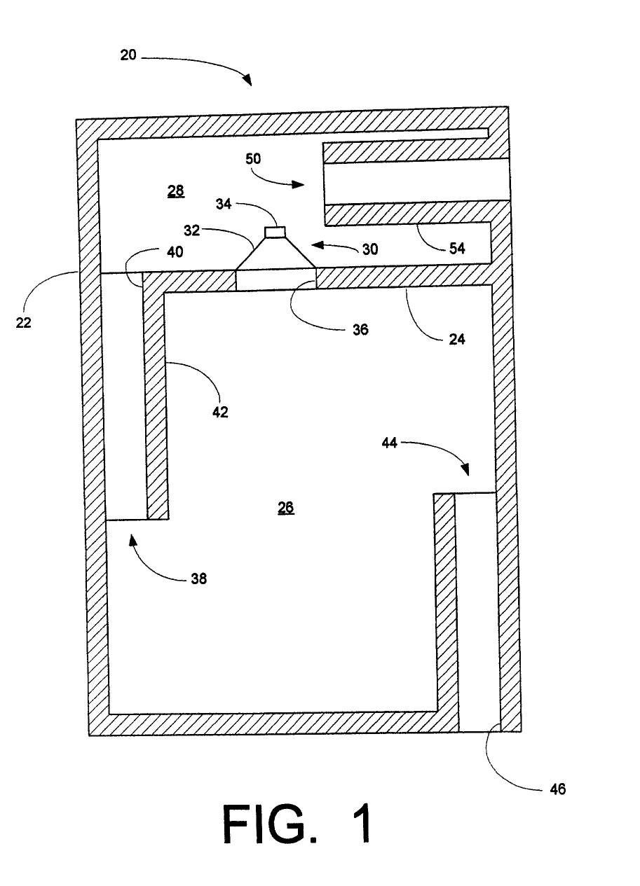

FIG. 1 shows a schematic representation of a loudspeaker system 20. The loudspeaker system 20 includes a housing or acoustical enclosure 22 separated by a dividing wall or baffle 24 into a first chamber or sub-chamber 26 and a second chamber or sub-chamber 28. An electro-acoustic transducer or loudspeaker 30 that includes a speaker cone 32 and a driver 34 (for connecting to a source (not shown) of audio signals for driving the speaker cone 32) is mounted in an opening 36 in the dividing wall 24, with a front surface of the speaker cone 32 in communication with the first sub-chamber 26 and a rear surface of the speaker cone 32 in communication with the second sub-chamber 28. The internal air volumes of both sub-chambers 26 and 28 are substantially reactive to the acoustic energy generated by the loudspeaker 30 in response to an electrical input signal to the driver 34. Preferably, the loudspeaker 30 and the opening 36 are sized so that the loudspeaker 30 completely fills the opening 36 so as to ensure that no air passes through the opening 36.

The acoustical enclosure 22 includes an internal vent 38 comprising an opening 40 in the dividing wall 24 adjacent to a wall of the acoustical enclosure 22 and a port tube 42 cooperating with the opening and extending into the first sub-chamber 26. The internal vent 38 pneumatically couples the first and second sub-chambers 26 and 28. The acoustical enclosure 22 further includes a first external vent 44, comprising an opening 46 in a bottom wall of the acoustical enclosure 22 and a port tube 48 cooperating with the opening 46 and extending into the first sub-chamber 26, for pneumatically coupling the first sub-chamber 26 with the exterior environment surrounding the loudspeaker system 20. In addition, the acoustical enclosure 22 includes a second external vent 50, comprising an opening 52 in a side wall of the acoustical enclosure 22 and a port tube 54 cooperating with the opening 52 and extending into the second sub-chamber 28, for pneumatically coupling the second sub-chamber 28 with the exterior environment surrounding the loudspeaker system 20. Thus, the acoustical enclosure 22 can be thought of as a dual-chamber, “triple-vented” enclosure.

The loudspeaker system 20 is designed so that both of the first and second external vents 44 and 50 significantly contribute to the overall acoustical output of the loudspeaker system 20. In general, this is accomplished by appropriate selection of various parameters of the loudspeaker system 20.

In particular, the ratio of the volumes of the first and second sub-chambers 26 and 28 is preferably in the range of 0.3 to 2.5, with the particular volume ratio selected being dependent upon the desired operating band (i.e., frequency band of the acoustical output) of the loudspeaker system 20 and the selected resonant frequency of the loudspeaker 30.

In particular, the ratio of the acoustic mass of the internal vent 38 (i.e., the mass of air in the internal vent 38) to the acoustic mass of the second external vent 50 is in the range of approximately 3/1 to 7/1, in order to achieve an appreciable improvement in the acoustical output of the loudspeaker system 20 over a reasonably broad operating band, with the particular ratio selected being largely dependent upon the selected operating band and the selected resonant frequency of the loudspeaker 30.

The port tubes 42, 48 and 54 may be of the type described in U.S. Pat. No. 4,875,546 to Krnan, the disclosure of which is herein incorporated by reference. As is described in greater detail in this patent, a port tube is an elongated hollow member open at both ends and sized to enclose a selected acoustic mass of air. Preferably, although not necessarily, each port tube is tubular.

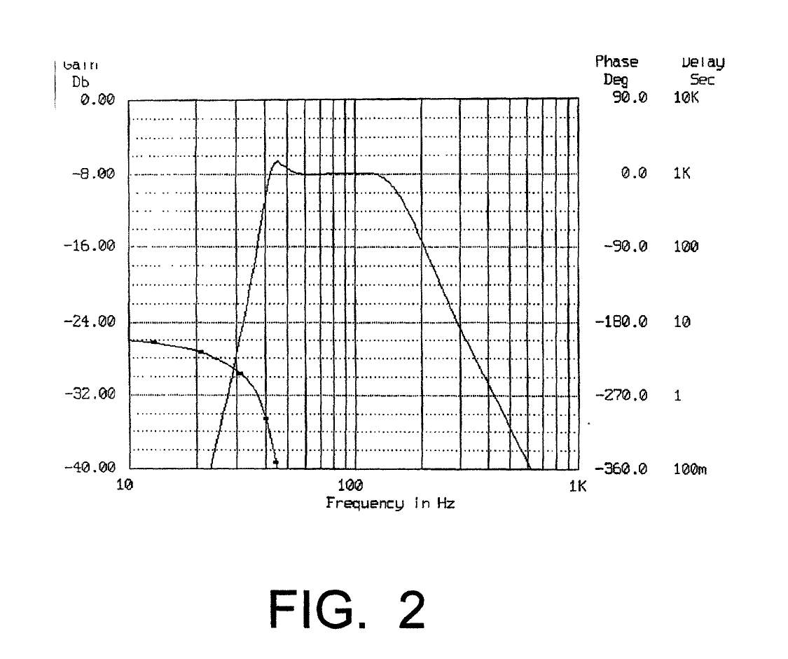

FIG. 2 shows a graph plotting the frequency response of the loudspeaker system 20 of FIG. 1.

Applicant has found that by replacing one or more of the port tubes 42, 48 and 54 with one or more passive radiators, respectively, significant improvements in the performance of the loudspeaker system 20 may be achieved.

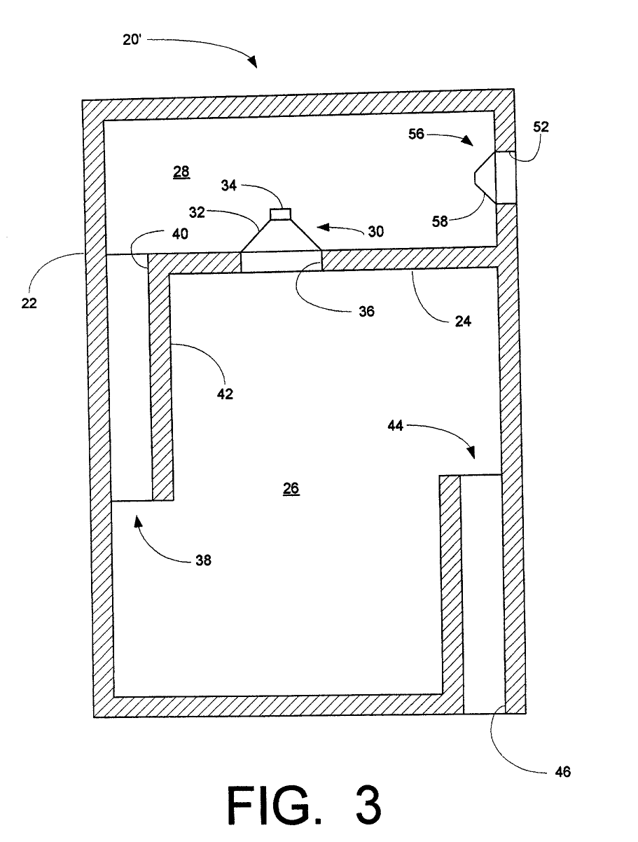

FIG. 3 shows a first embodiment of a loudspeaker system 20′ substantially similar to that shown in FIG. 1. However, as should be apparent, the port tube 54 has been replaced by a passive radiator 56 having a speaker cone 58 which is arranged to cover the opening 52. A passive radiator is substantially similar to a loudspeaker with the exception that it does not have a driver. As the name suggests, the passive radiator is not driven directly by an audio signal. Rather, the passive radiator picks up acoustic vibrations within the loudspeaker enclosure 22 and generate sympathetic vibrations in dependence on its resonant frequency.

One of the advantages that can accrue from using a passive radiator in lieu of a port tube is that it takes up less space in the loudspeaker enclosure thereby effectively increasing the usable internal of the enclosure. Alternatively, a smaller loudspeaker enclosure may be used having substantially the same acoustic performance of a larger loudspeaker enclosure in which only port tubes are used.

In a particular embodiment of the subject invention, in a loudspeaker enclosure having an internal volume of approximately 14.78 liters, a 4 inch diameter passive radiator 56 having an 8 gram diaphragm (speaker cone 58) and a resonant frequency of 150 Hz is used to replace a 3″ diameter port tube that would have to be 13.54 inches in length. It should be apparent that this size port tube would take away appreciable volume from the 14.78 liter enclosure.

The passive radiator can also reduce the amount of mass required to tune the system for improved acoustic performance. The mass of the port tube which the passive radiator 56 replaced in the above example would have to be 181 grams to satisfy the design conditions of a 45 Hz cutoff, this is in contrast with the 8 gram diaphragm of the passive radiator 56.

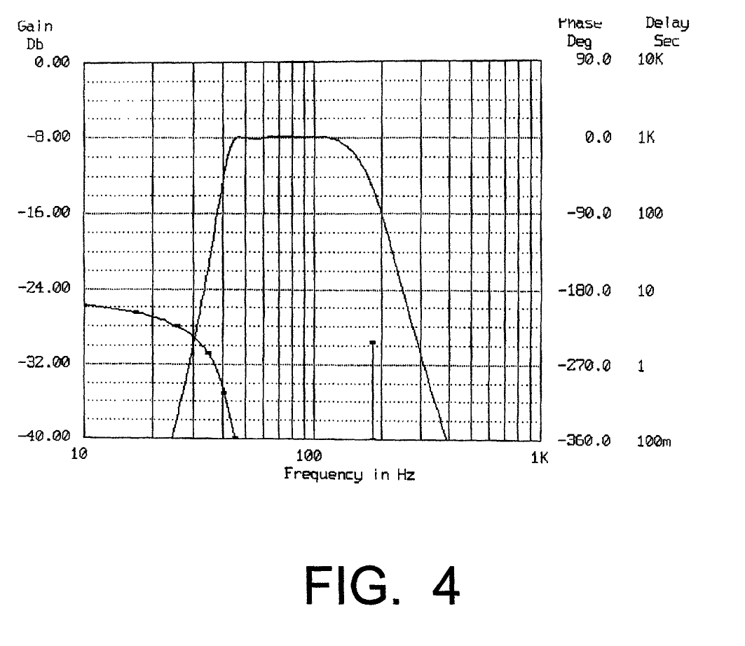

FIG. 4 shows the frequency response of the loudspeaker system 20′ of FIG. 3. It should be noted that this frequency response is substantially similar to that shown in FIG. 2 for the loudspeaker system 20 of FIG. 1.

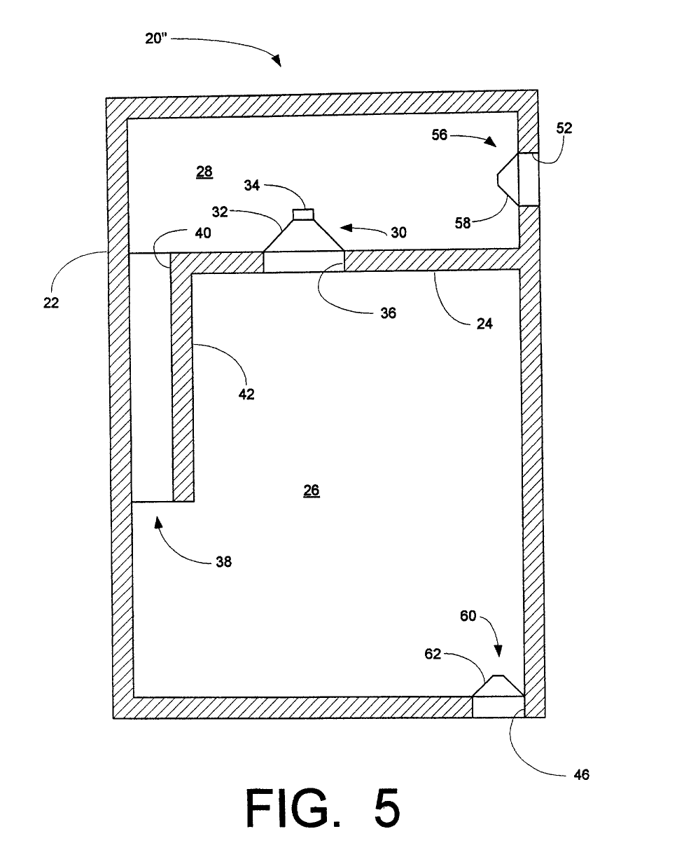

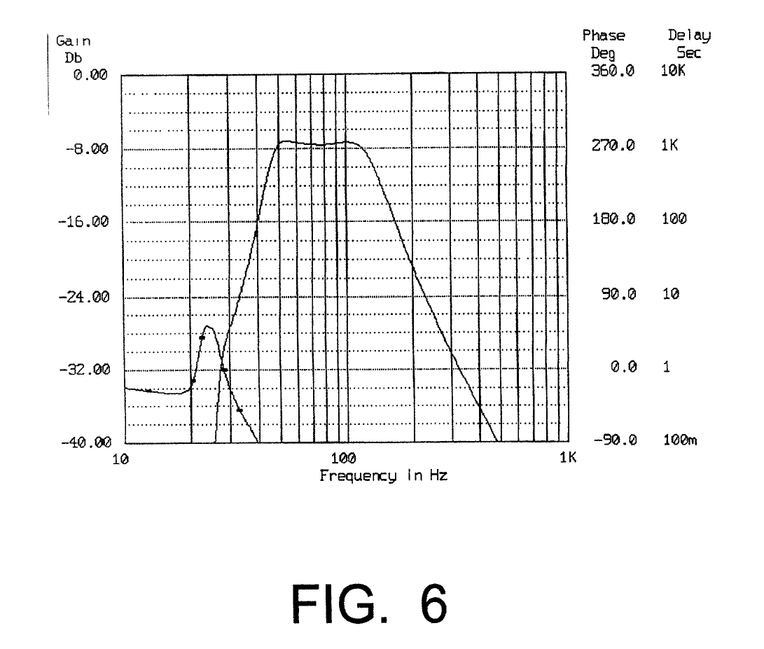

FIG. 5 shows a second embodiment of the subject invention in which in addition to the passive radiator 56 of FIG. 3, the loudspeaker system 20′ includes a second passive radiator 60 for replacing the port tube 48. As with the passive radiator 56, the passive radiator 60 has a 4 inch diameter diaphragm 62. FIG. 6 shows the frequency response curve for the loudspeaker system 20″.

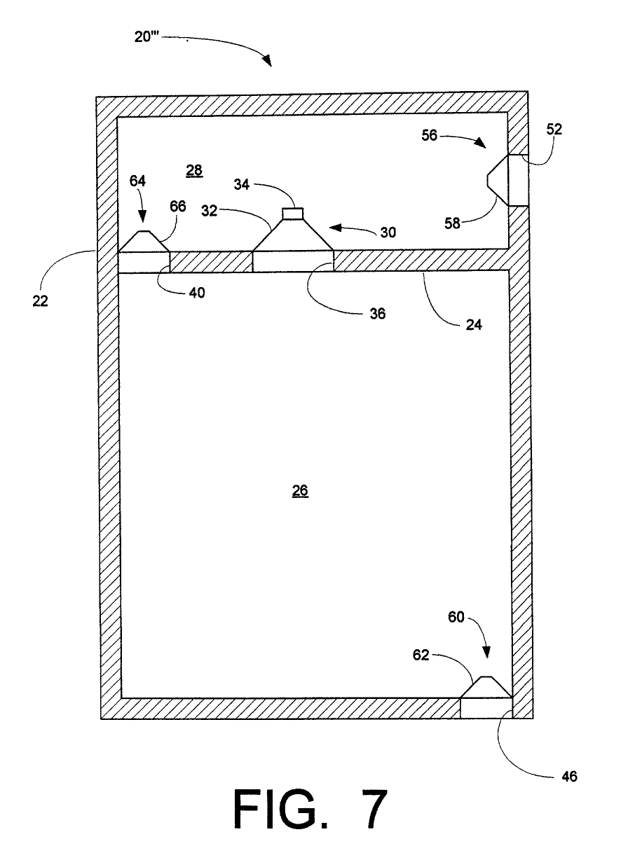

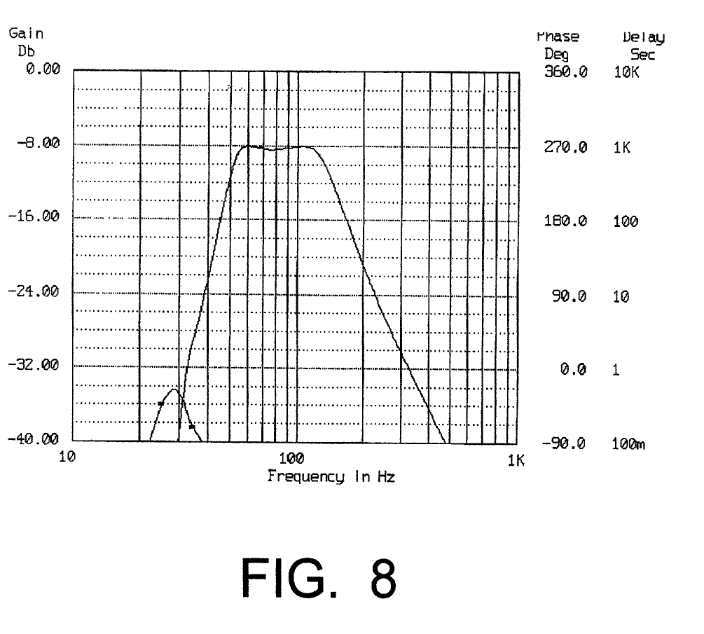

FIG. 7 shows a third embodiment of the subject invention, in which the loudspeaker system 20″′ includes a third passive radiator 64 with a diaphragm 66 for replacing the internal port tube 42. Finally, FIG. 8 shows the frequency response curve for the loudspeaker system 20″′.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

What is claimed is:

1. A loudspeaker system comprising:
an acoustical enclosure having an internal wall dividing the acoustical enclosure into a first sub-chamber and a second sub-chamber, the internal wall being provided with an opening;
an electro-acoustic transducer having a vibratable speaker cone, the electro-acoustic transducer being mounted in the opening provided in the internal wall of the acoustical enclosure;
an internal vent provided in the internal wall of the acoustical enclosure for pneumatically coupling the first and second sub-chambers;
a first external vent provided in a wall of one of the first and second sub-chambers for pneumatically coupling said one of the first and second sub-chambers to an exterior environment outside of the acoustical enclosure;
a wall of the other of the first and second sub-chambers being provided with an opening for communicating with the exterior environment outside of the acoustical enclosure; and
a passive radiator mounted in the opening in the wall of the other of the first and second sub-chambers.

2. The loudspeaker system as claimed in claim 1, wherein the vibratable speaker cone of the electro-acoustical transducer has a front surface for communicating with the first sub-chamber, and a rear surface for communicating with the second sub-chamber.

3. The loudspeaker system as claimed in claim 2, wherein said one of the first and second sub-chambers having the external vent is the first sub-chamber, and wherein the other of the first and second sub-chambers having the opening bearing the passive radiator is the second sub-chamber.

4. The loudspeaker system as claimed in claim 1, wherein the passive radiator has a diameter of 4 inches.

5. The loudspeaker system as claimed in claim 1, wherein the passive radiator has a diaphragm with a mass of 8 grams.

6. A loudspeaker system comprising:
an acoustical enclosure having an internal wall dividing the acoustical enclosure into a first sub-chamber and a second sub-chamber, the internal wall being provided with an opening;
an electro-acoustic transducer having a vibratable speaker cone, the electro-acoustic transducer being mounted in the opening provided in the internal wall of the acoustical enclosure;
an internal vent provided in the internal wall of the acoustical enclosure for pneumatically coupling the first and second sub-chambers;
a wall of one of the first and second sub-chambers being provided with a first opening for pneumatically coupling said one of the first and second sub-chambers to an exterior environment outside of the acoustical enclosure;
a wall in the other of the first and second sub-chambers being provided with a second opening for pneumatically coupling said other of the first and second sub-chambers to the exterior environment outside of the acoustical enclosure;
a first passive radiator mounted in the first opening in the wall of the one of the first and second sub-chambers; and
a second passive radiator mounted in the second opening in the wall of the other of the first and second sub-chambers.

7. The loudspeaker system as claimed in claim 6, wherein the vibratable speaker cone of the electro-acoustical transducer has a front surface for communicating with the first sub-chamber, and a rear surface for communicating with the second sub-chamber.

8. The loudspeaker system as claimed in claim 7, wherein said one of the first and second sub-chambers having the first opening is the first sub-chamber, and wherein the other of the first and second sub-chambers having the second opening is the second sub-chamber.

9. The loudspeaker system as claimed in claim 6, wherein the first and second passive radiators each has a diameter of 4 inches.

10. The loudspeaker system as claimed in claim 6, wherein the first and second passive radiators each has a diaphragm with a mass of 8 grams.

11. A loudspeaker system comprising:
an acoustical enclosure having an internal wall dividing the acoustical enclosure into a first sub-chamber and a second sub-chamber, the internal wall being provided with an opening;
an electro-acoustic transducer having a vibratable speaker cone, the electro-acoustic transducer being mounted in the opening provided in the internal wall of the acoustical enclosure;
a further opening provided in the internal wall of the acoustical enclosure for pneumatically coupling the first and second sub-chambers;
a wall of one of the first and second sub-chambers being provided with a first opening for pneumatically coupling said one of the first and second sub-chambers to an exterior environment outside of the acoustical enclosure;
a wall in the other of the first and second sub-chambers being provided with a second opening for pneumatically coupling said other of the first and second sub-chambers to the exterior environment outside of the acoustical enclosure;
a first passive radiator mounted in the first opening in the wall of the one of the first and second sub-chambers;
a second passive radiator mounted in the second opening in the wall of the other of the first and second sub-chambers; and
a third passive radiator mounted in the further opening in the internal wall of the acoustical enclosure.

12. The loudspeaker system as claimed in claim 11, wherein the vibratable speaker cone of the electro-acoustical transducer has a front surface for communicating with the first sub-chamber, and a rear surface for communicating with the second sub-chamber.

13. The loudspeaker system as claimed in claim 12, wherein said one of the first and second sub-chambers having the first opening is the first sub-chamber, and wherein the other of the first and second sub-chambers having the second opening is the second sub-chamber.

14. The loudspeaker system as claimed in claim 11, wherein the first, second and third passive radiators each has a diameter of 4 inches.

15. The loudspeaker system as claimed in claim 11, wherein the first, second and third passive radiators each has a diaphragm with a mass of 8 grams.
